(19) United States
(12) Patent Application Publication
(10) Pub. No.: US 2011/0276747 A1
(43) Pub. Date: Nov. 10, 2011

(54) SOFTWARE MANAGEMENT WITH HARDWARE TRAVERSAL OF FRAGMENTED LLR MEMORY

(75) Inventors: Robert Jason Fuchs, San Diego, CA (US); Michael A. Kongelf, San Diego, CA (US); Christian O. Thelen, San Diego, CA (US); Rajat R. Dhawan, San Diego, CA (US); Hao Xu, San Diego, CA (US)

(73) Assignee: QUALCOMM INCORPORATED, San Diego, CA (US)

(21) Appl. No.: 13/101,947

(22) Filed: May 5, 2011

Related U.S. Application Data
(60) Provisional application No. 61/332,580, filed on May 7, 2010.

(51) Int. Cl. G06F 12/00; G06F 12/02

(52) U.S. Cl. 711/103; 711/154; 711/E12.002; 711/E12.008

(57) ABSTRACT

Certain aspects of the present disclosure relate to a method and apparatus for processing wireless communications. According to certain aspects, a linked list of chunks of memory used to store logarithmic likelihood ratio (LLR) values for a transport block is generated. Each chunk holds LLR values for a code block of the transport block. The linked list is then provided to a hardware circuit for traversal. According to certain aspects, the hardware circuit may be an application specific integrated circuit (ASIC) processor or field programmable gate array (FPGA) configured to traverse the linked list of chunks of memory used to store LLR values.

### CLAIM OF PRIORITY UNDER 35 U.S.C. §119

The present application for patent claims benefit of Provisional Application Ser. No. 61/332,580, entitled “Software Management with Hardware Traversal of Fragmented LLR Memory”, filed May 7, 2010, and assigned to the assignee hereof and hereby expressly incorporated by reference herein

### BACKGROUND

1. Field

Certain aspects of the present disclosure generally relate to wireless communications.

2. Background

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP Long Term Evolution (LTE) systems, worldwide interoperability for microwave access (WiMAX), orthogonal frequency division multiple access (OFDMA) systems, etc.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-in-single-out, multiple-in-single-out or a multiple-in-multiple-out (MIMO) system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min{N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

In addition, base stations can utilize log-likelihood ratios (LLR) to support decoding transport blocks received from mobile terminals. Generally, LLRs are generated while decoding received code symbols to determine a degree of certainty of the decoding. A LLR may be regarded as a probability that a transmitted code symbol is a “1” over the probability that the transmitted code symbol is a “0”. The LLRs may be used to determine, for example, whether to request a re-transmission of the transport blocks or to request transmission of the transport blocks with additional redundancy information. As such, the LRRs are stored by base stations until at least user termination or successful receipt of the transport blocks is confirmed.

### SUMMARY

Certain aspects of the present disclosure provide a method for wireless communications. The method generally includes generating a linked list of chunks of memory used to store logarithmic likelihood ratio (LLR) values for a transport block. Each chunk may hold LLR values for a code block of the transport block. The method further includes providing the linked list to a hardware circuit for traversal.

Certain aspects of the present disclosure provide an apparatus for wireless communications. The apparatus generally includes a logarithmic likelihood ratio (LLR) memory for storing logarithmic likelihood ratio (LLR) values of a transport block and a linked list manager configured to generate a linked list of chunks of the LLR memory. According to certain aspects, each chunk holds LLR values for a code block of the transport block. The apparatus further includes a hardware circuit configured to traverse the linked list as provided by the linked list manager.

Certain aspects of the present disclosure provide an apparatus for wireless communications. The apparatus generally includes means for generating a linked list of chunks of memory used to store logarithmic likelihood ratio (LLR) values for a transport block, wherein each chunk holds LLR values for a code block of the transport block. The apparatus further includes means for providing the linked list to a hardware circuit for traversal.

Certain aspects of the present disclosure provide a computer-program product comprising a computer-readable medium having instructions stored thereon. The instructions may be executable by one or more processors for generating a linked list of chunks of memory used to store logarithmic likelihood ratio (LLR) values for a transport block, wherein each chunk holds LLR values for a code block of the transport block, and providing the linked list to a hardware circuit for traversal.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout and wherein:

FIG. 1 illustrates a multiple access wireless communication system according to certain aspects of the present disclosure.

FIG. 2 illustrates a block diagram of a communication system.

FIG. 3 illustrates an example communications apparatus that manages linked lists of LLR memory chunks for traversal by a specific hardware circuit.

FIG. 4 illustrates an exemplary method for managing memory according to certain aspects of the present disclosure.

FIGS. 5A-5D illustrate example linked list for traversal by a specific hardware circuit.

FIG. 6 illustrates an exemplary chunk configuration for storing LLR values according to certain aspects of the present disclosure.

### DESCRIPTION

Certain aspects of the present disclosure provide techniques for managing memory utilized to store LLR values for wireless communications. An LTE eNodeB base station serves a wide array of users which may have varied resource demands. For example, a base station may communicate with hundreds of small users with small transport block sizes, where the base station needs to calculate and store of on the order of a hundred LLRs. In another example, a base station may communicate with one high data rate user, the high data rate user needing calculation and storage of tens of thousands of LLRs. In some cases, an LTE eNodeB base station has a fixed amount of memory dedicated to storing these LLRs. This presents a challenge for how to effectively manage LLR memory. Statically allocating the same amount of LLR memory for each user may result in unused, wasted memory. As such, there is a demand for techniques and processes to efficiently and flexibly manage LLR memory. Certain aspects of the present disclosure provided techniques for managing LLR memory to handle varied and diverse user scenarios, as mentioned above.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3rd Generation Partnership Project” (3GPP). cdma2000 is described in documents from an organization named “3rd Generation Partnership Project 2” (3GPP2). These various radio technologies and standards are known in the art. For clarity, certain aspects of the techniques are described below for LTE, and LTE terminology is used in much of the description below.

Single carrier frequency division multiple access (SC-FDMA), which utilizes single carrier modulation and frequency domain equalization is a technique. SC-FDMA has similar performance and essentially the same overall complexity as those of OFDMA system. SC-FDMA signal has lower peak-to-average power ratio (PAPR) because of its inherent single carrier structure. SC-FDMA has drawn great attention, especially in the uplink communications where lower PAPR greatly benefits the mobile terminal in terms of transmit power efficiency. It is currently a working assumption for uplink multiple access scheme in 3GPP Long Term Evolution (LTE), or Evolved UTRA.

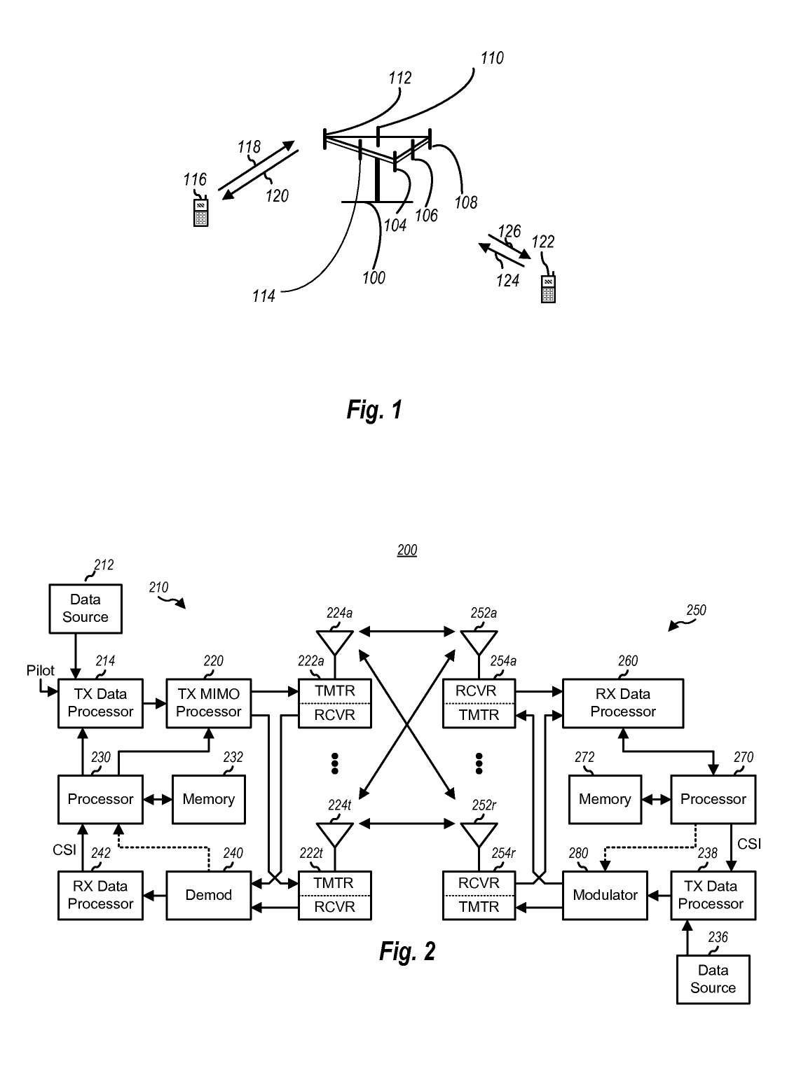

Referring to FIG. 1, a multiple access wireless communication system according to certain aspects of the present disclosure is illustrated. An access point 100 (AP) includes multiple antenna groups, one including antennas 104 and 106, another including antennas 108 and 110, and an additional including antennas 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal 122 is in communication with antennas 106 and 108, where antennas 106 and 108 transmit information to access terminal 122 over forward link 126 and receive information from access terminal 122 over reverse link 124. In a FDD system, communication links 118, 120, 124 and 126 may use different frequency for communication. For example, forward link 120 may use a different frequency then that used by reverse link 118. According to certain aspects of the present disclosure, as mentioned above, the access point 100 may be in communication with a plurality of access terminals, such access terminal 116. The plurality of access terminals may use various transmission data rates in communication with the access point 100. For example, one access terminal 116 may have a low data rate comprising small transport blocks, while another access terminal 116 may have a high data rate having very large transport blocks.

Each group of antennas and/or the area in which they are designed to communicate is often referred to as a sector of the access point. In the aspect shown in FIG. 1, each antenna group each is designed to communicate to access terminals in a sector of the areas covered by access point 100.

In communication over forward links 120 and 126, the transmitting antennas of access point 100 utilize beamforming in order to improve the signal-to-noise ratio of forward links for the different access terminals 116 and 122. Also, an access point using beamforming to transmit to access terminals scattered randomly through its coverage causes less interference to access terminals in neighboring cells than an access point transmitting through a single antenna to all its access terminals.

An access point may be a fixed station used for communicating with the terminals and may also be referred to as a base station, a Node B, E-UTRAN Node B, sometimes referred to as an “evolved Node B” (eNodeB or eNB), or some other terminology. An access terminal may also be called a user terminal, a mobile station (MS), user equipment (UE), a wireless communication device, terminal, or some other terminology. Moreover, an access point can be a macrocell access point, femtocell access point, picocell access point, and/or the like.

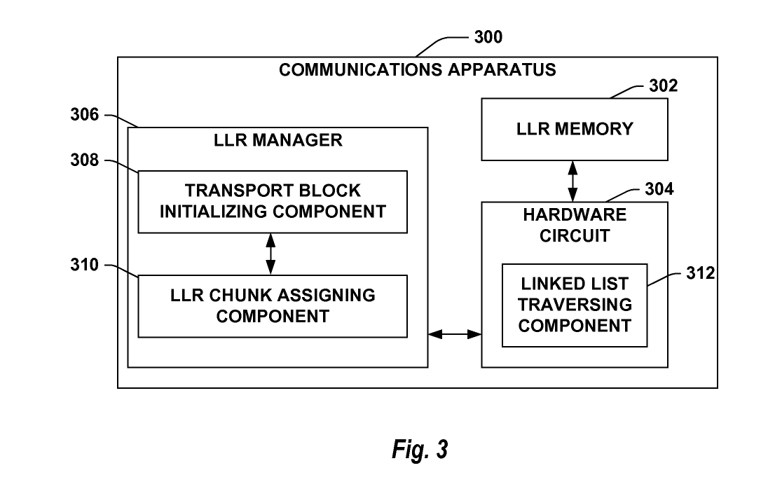

FIG. 2 is a block diagram of certain aspects of a transmitter system 210 (also known as the access point) and a receiver system 250 (also known as access terminal) in a MIMO system 200. At the transmitter system 210, traffic data for a number of data streams is provided from a data source 212 to a transmit (TX) data processor 214.

In an aspect, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain aspects, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message. According to certain aspects of the present disclosure, the RX data processor 242 may further process the modulated signals from the receiver system 250 to generate a plurality of LLR values.

According to certain aspects, the transmitter system 210 includes a memory 232 configured to store intermediate data values generated and utilized during processing of the modulated signals from the receiver system 250. According to certain aspects, some portion of the memory 232 may be used as LLR memory. The LLR memory comprises a fixed amount of memory configured to store a plurality of LLR values According to certain aspects, the LLR memory may be divided into a plurality of chunks, wherein each chunk may hold up to a pre-determined amount of LLRs each. For example, the LLR memory may be divided into at least 3520 chunks, wherein each chunk holds 1024 LLRs.

The processor 230 may be configured to manage the LLR memory utilizing techniques according to certain aspects of the present disclosure. For example, the processor 230 may generate and manage a linked list having nodes corresponding to chunks of LLR memory. The processor 230 may be configured to perform various data structure operations on the linked list, including allocation, de-allocation, sorting, and searching. The linked list may be configured according to a configuration described in detail below. According to certain aspects, linked list management is performed in L1 software. While aspects of the present disclosure are described in relation to a linked list data structure, it is understood that other suitable data structures are contemplated, including, but not limited to, heaps, hash tables, and trees.

According to certain aspects, the processor 230 may include a hardware circuit configured to access the LLR memory utilizing a linked list according to techniques discussed further below. According to certain aspects, the hardware circuit may be an application specific integrated circuit (ASIC), a field programmable gate array (FPGA), a configurable logic block (CLB), or a specific purpose processor.

In an aspect, logical channels are classified into Control Channels and Traffic Channels. Logical Control Channels comprises Broadcast Control Channel (BCCH) which is DL channel for broadcasting system control information. Paging Control Channel (PCCH) which is DL channel that transfers paging information. Multicast Control Channel (MCCH) which is Point-to-multipoint DL channel used for transmitting Multimedia Broadcast and Multicast Service (MBMS) scheduling and control information for one or several MTCHs. Generally, after establishing RRC connection this channel is only used by UEs that receive MBMS (Note: old MCCH+MSCH). Dedicated Control Channel (DCCH) is Point-to-point bi-directional channel that transmits dedicated control information and used by UEs having an RRC connection. In aspect, Logical Traffic Channels comprises a Dedicated Traffic Channel (DTCH) which is Point-to-point bi-directional channel, dedicated to one UE, for the transfer of user information. Also, a Multicast Traffic Channel (MTCH) for Point-to-multipoint DL channel for transmitting traffic data.

In an aspect, Transport Channels are classified into DL and UL. DL Transport Channels comprises a Broadcast Channel (BCH), Downlink Shared Data Channel (DL-SDCH) and a Paging Channel (PCH), the PCH for support of UE power saving (DRX cycle is indicated by the network to the UE), broadcasted over entire cell and mapped to PHY resources which can be used for other control/traffic channels. The UL Transport Channels comprises a Random Access Channel (RACH), a Request Channel (REQCH), an Uplink Shared Data Channel (UL-SDCH) and plurality of PHY channels. The PHY channels comprise a set of DL channels and UL channels.

The DL PHY channels comprises:

Common Pilot Channel (CPICH)

Synchronization Channel (SCH)

Common Control Channel (CCCH)

Shared DL Control Channel (SDCCH)

Multicast Control Channel (MCCH)

Shared UL Assignment Channel (SUACH)

Acknowledgement Channel (ACKCH)

DL Physical Shared Data Channel (DL-PSDCH)

UL Power Control Channel (UPCCH)

Paging Indicator Channel (PICH)

Load Indicator Channel (LICH)

The UL PHY Channels comprises:

Physical Random Access Channel (PRACH)

Channel Quality Indicator Channel (CQICH)

Acknowledgement Channel (ACKCH)

Antenna Subset Indicator Channel (ASICH)

Shared Request Channel (SREQCH)

UL Physical Shared Data Channel (UL-PSDCH)

Broadband Pilot Channel (BPICH)

In an aspect, a channel structure is provided that preserves low PAR (at any given time, the channel is contiguous or uniformly spaced in frequency) properties of a single carrier waveform.

For the purposes of the present document, the following abbreviations apply:

ACK Acknowledgement

AM Acknowledged Mode

AMD Acknowledged Mode Data

ARQ Automatic Repeat Request

BCCH Broadcast Control CHannel

BCH Broadcast CHannel

BW Bandwidth

C- Control-

CB Contention-Based

CCE Control Channel Element

CCCH Common Control CHannel

CCH Control CHannel

CCTrCH Coded Composite Transport Channel

CDM Code Division Multiplexing

CF Contention-Free

CP Cyclic Prefix

CQI Channel Quality Indicator

CRC Cyclic Redundancy Check

CRS Common Reference Signal

CTCH Common Traffic CHannel

DCCH Dedicated Control CHannel

DCH Dedicated CHannel

DCI Downlink Control Information

DL DownLink

DRS Dedicated Reference Signal

DSCH Downlink Shared Channel

DSP Digital Signal Processor

DTCH Dedicated Traffic CHannel

E-CID Enhanced Cell IDentification

EPS Evolved Packet System

FACH Forward link Access CHannel

FDD Frequency Division Duplex

FDM Frequency Division Multiplexing

FSTD Frequency Switched Transmit Diversity

HARQ Hybrid Automatic Repeat/request

HW Hardware

IC Interference Cancellation

L1 Layer 1 (physical layer)

L2 Layer 2 (data link layer)

L3 Layer 3 (network layer)

LI Length Indicator

LLR Log-Likelihood Ratio

LSB Least Significant Bit

MAC Medium Access Control

MBMS Multimedia Broadcast Multicast Service

MCCH MBMS point-to-multipoint Control Channel

MMSE Minimum Mean Squared Error

MRW Move Receiving Window

MSB Most Significant Bit

MSCH MBMS point-to-multipoint Scheduling CHannel

MTCH MBMS point-to-multipoint Traffic CHannel

NACK Non-Acknowledgement

PA Power Amplifier

PBCH Physical Broadcast CHannel

PCCH Paging Control CHannel

PCH Paging CHannel

PCI Physical Cell Identifier

PDCCH Physical Downlink Control CHannel

PDU Protocol Data Unit

PHICH Physical HARQ Indicator CHannel

PHY PHYsical layer

PhyCH Physical CHannels

PMI Precoding Matrix Indicator

PRACH Physical Random Access Channel

PSS Primary Synchronization Signal

PUCCH Physical Uplink Control CHannel

PUSCH Physical Uplink Shared CHannel

QoS Quality of Service

RACH Random Access CHannel

RB Resource Block

RLC Radio Link Control

RRC Radio Resource Control

RE Resource Element

RI Rank Indicator

RNTI Radio Network Temporary Identifier

RS Reference Signal

RTT Round Trip Time

Rx Receive

SAP Service Access Point

SDU Service Data Unit

SFBC Space Frequency Block Code

SHCCH SHared channel Control CHannel

SNR Signal-to-Interference-and-Noise Ratio

SN Sequence Number

SR Scheduling Request

SRS Sounding Reference Signal

SSS Secondary Synchronization Signal

SU-MIMO Single User Multiple Input Multiple Output

SUFI SUper Field

SW Software

TA Timing Advance

TCH Traffic CHannel

TDD Time Division Duplex

TDM Time Division Multiplexing

TFI Transport Format Indicator

TPC Transmit Power Control

TTI Transmission Time Interval

Tx Transmit

U- User-

UE User Equipment

UL UpLink

UM Unacknowledged Mode

UMD Unacknowledged Mode Data

UMTS Universal Mobile Telecommunications System

UTRA UMTS Terrestrial Radio Access

UTRAN UMTS Terrestrial Radio Access Network

VOIP Voice Over Internet Protocol

MBSFN multicast broadcast single frequency network

MCH multicast channel

DL-SCH downlink shared channel

PDCCH physical downlink control channel

PDSCH physical downlink shared channel

According to certain aspects of the present disclosure, a hardware and software configuration may be utilized to support a varying number of LTE UL transport blocks. In certain aspects, a varying number of transport block and code block sizes may be stored efficiently in an LLR memory, wherein the LLR memory is subdivided into chunks and the chunks are grouped together via a series of linked lists, with one linked list managed per transport block. According to certain aspects, Layer 1 (L1) software handles management of the linked lists, while a hardware circuit traverses the linked lists.

According to an example, as described herein, LLR memory can be apportioned into a number of chunks each comprising a number of LLRs, and a number of chunks can be allocated to a given transport block. Chunks for a given transport block can be associated in a linked list to provide multiple chunks for the transport block. The linked lists can be defined and managed using a general purpose processor, and the linked lists can be traversed by a hardware circuit to determine data related to one or more transport blocks in the chunks of LLRs. In this regard, changes in the linked list management can be made to software or configuration information, which can be utilized by a general purpose processor, without requiring expensive hardware changes to the hardware circuit.

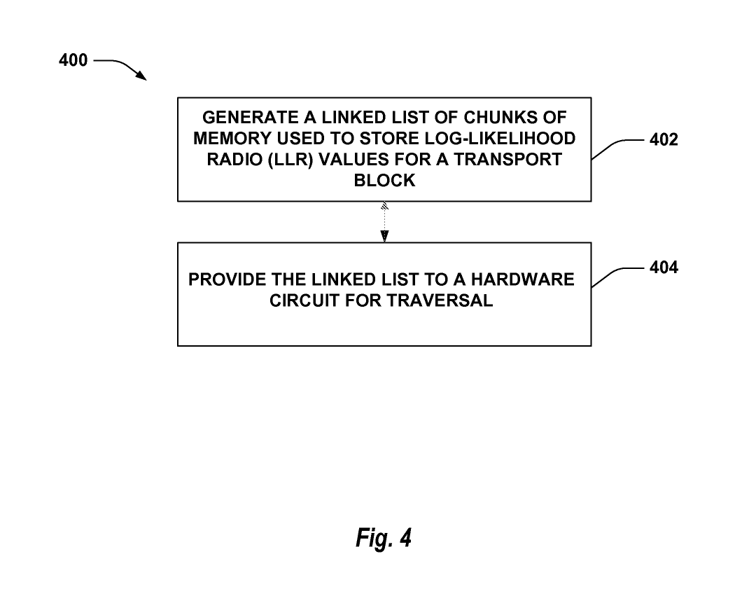

FIG. 3 illustrates a communications apparatus 300 according to certain aspects of the present disclosure that facilitates generating and utilizing linked lists that reference a set of LLR chunks for a transport block. Communications apparatus 300 may be an access point, such as a macrocell, femtocell, picocell, etc. access point, a relay node, a mobile base station, a portion thereof, and/or substantially any wireless device that transmits signals to one or more disparate devices in a wireless network. In certain aspects, the communications apparatus 300 may be the access point 210 described in FIG. 2.

Communications apparatus 300 generally includes an LLR memory 302, an LLR manager 306, and a hardware circuit 304 that performs one or more specific functions. The LLR memory 302 may be a fixed amount of memory suitable for storing a plurality of LLRs indicating a probability of a properly received bit. The hardware circuit 304 is configured to perform one or more specific functions pertaining to the LLR memory 302, such as traversing and accessing the LLR memory. According to certain aspects, the hardware circuit 304 comprises a linked list traversing component 312 that is configured to process a linked list to determine LLR data related to a transport block.

Generally, the LLR manager 306 manages the LLR memory 302 by maintaining a linked list of allocated LLR memory space and a list of available LLR memory, described in further detail below. The LLR manager 306 includes a transport block initializing component 308 that creates a transport block for one or more wireless devices and an LLR chunk assigning component 310 that links together chunks that store LLR values corresponding to the transport block. It is to be appreciated that the foregoing components of the LLR manager 306 can be implemented using a general purpose processor (not shown), which can utilize a separate memory or firmware for storing instructions related thereto, etc. In addition, the general purpose processor can be an independent processor, located within one or more processors, and/or the like.

According to an example, transport block initializing component 308 can define transport blocks for communication with one or more wireless devices. For example, transport block initializing component 308 can determine a transport block size for a wireless device based at least in part on data requirements of the wireless device, available transport blocks or LLRs, and/or the like.

The LLR manager 306 may be configured to divide the LLR memory 302 into a plurality of chunks, and then group LLRs in the LLR memory 302 into the chunks. A chunk may comprise a unit of storage of LLR memory 302. According to certain aspects, a subset of the plurality of chunks may store LLR values corresponding to a code block of data, wherein the code block is a part of a transport block. The chunks can be substantially the same size or may have a varied size. In certain aspects, the hardware circuit 304 may determine the chunk size for processing the chunks. In one specific example, the LLR manager 306 can group LLR memory space into 3,520 chunks, wherein each chunk can store up to 1,024 LLRs.

Given a specified transport block size, the LLR chunk assigning component 310 can allocate one or more LLR chunks to store LLRs corresponding to a transport block for the one or more wireless devices. The LLR manager 306 may utilize a transport block comprising a plurality of code blocks to provide additional granularity for varying transport block size. According to certain aspects where a transport block may comprise a plurality of code blocks, the LLR chunk assigning component 310 may allocate at least one LLR chunk for storing the LLRs of each code block.

In this example, the LLR chunk assigning component 310 may link together the LLR chunks corresponding to the code blocks that comprise the transport block.

The LLR manager 306 maintains a linked list data structure that stores linkages between chunks linked by the LLR chunk assignment component 310. The LLR manager 306 may further be configured to provide the linked list (e.g., of linked chunks) to the hardware circuit 304 for traversal. For example, the LLR manager 306 may write the linked list to a memory within the hardware circuit 304 and/or linked list traversing component 312.

To read and/or write data related to a corresponding transport block, linked list traversing component 312 of the hardware circuit 304 can process the linked list to access the chunks in the LLR memory 302 that correspond to the transport block. For example, given a linked list, the linked list traversing component 312 can step through each LLR chunk in the list, extracting LLR data stored in the chunks. In this regard, linked list management is performed by the components 306, 308, and/or 310 while the hardware circuit 304 only traverses the list. Thus, if changes are required in list management, changes can be made to the components 306, 308, and/or 310 (e.g., in software) without requiring change to the hardware circuit 304. It is to be appreciated that the hardware circuit 304 and the LLR manager 306 can receive or determine the same LLR chunk size to facilitate proper linked list management and traversal.

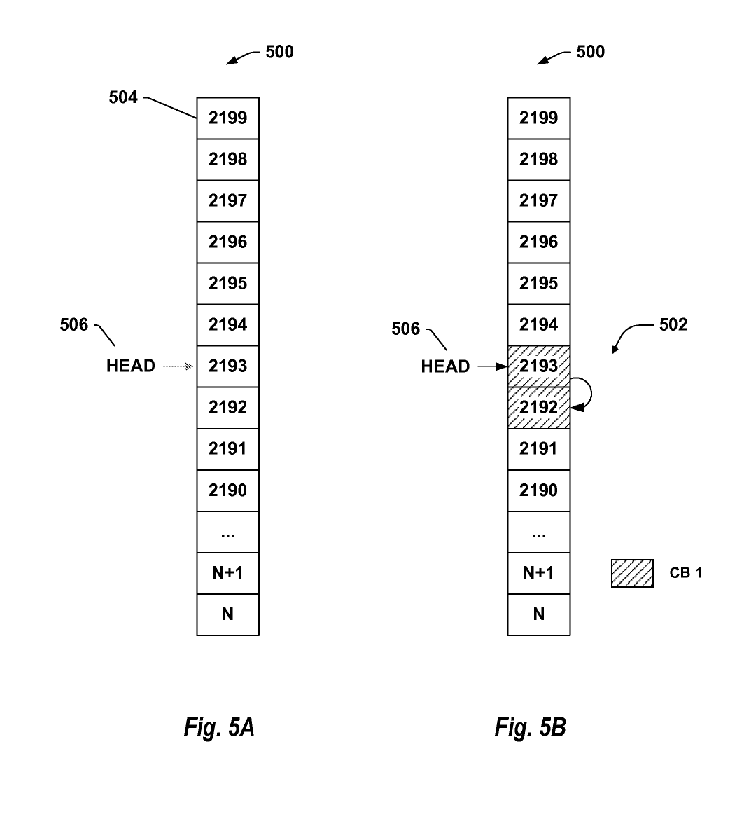

FIG. 4 illustrates example operations 400 for managing LLR memory according to aspects of the present disclosure. At 402, a linked list of chunks of memory used to store logarithmic likelihood ratio (LLR) values for a transport block may be generated. As described, the linked list can be specified in memory according to a chunk configuration to allow traversal by separate entity. In addition, each chunk of memory may hold LLR values for code blocks of varying size that comprise a transport block. As noted above, these example operations 400 may be performed by a general purpose processor executing processes such as L1 software.

The operations 400 continue at 404, where the linked list is provided to a hardware circuit for traversal. According to certain aspects, the linked list may be provided to the hardware circuit as a pointer to a head of the linked list.

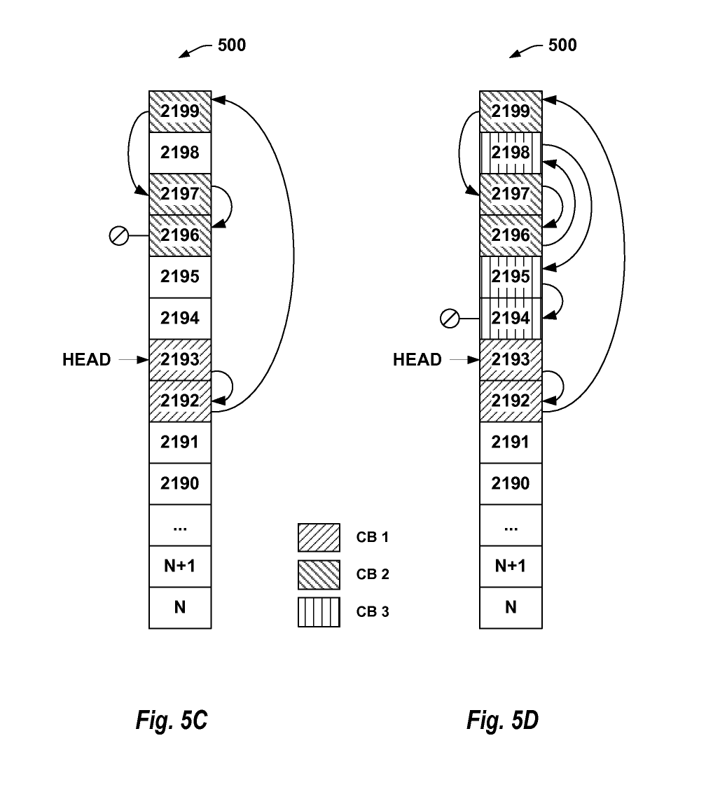

FIGS. 5A-5D illustrate a linked list 502 of chunks 504 of LLR memory 500 generated by one or more components described herein according to certain aspects of the present disclosure, such as the LLR manager 306. The linked list 502 corresponds to a given transport block and tracks the LLR memory used to store LLR values for the given transport block. As described, list management software operating on a general purpose processor can store LLRs for variable-sized transport blocks (e.g., based on communication requirements, and/or the like, as described) as a number of linked LLR chunks. Parameters pertaining to the linked list 502, such as a list head 508 related to a given transport block, can be passed to a processor, such as hardware circuit 304, for traversal of the linked list 502.

FIG. 5A illustrates an LLR memory 500 divided into chunks 504 according to aspects of the present disclosure. As shown in an initialized state, all chunks 504 of LLR memory 500 are unused and are available for storage of LLRs. Unused chunks may be set to a NULL or to a pre-determined initial value. In the example depicted in FIGS. 5A-5D, the chunks 504 are identified as chunks “2199”, “2198”, “2197”, . . . “N+1”, “N”. In the example shown in FIG. 5A, a head pointer 506 is initialized to indicate chunk 2193.

It is understood that one or more components, such as the LLR manager 306, may track and/or monitor unused chunks 504 as part of a linked list management process according to aspects of the present disclosure. For example, the LLR manager 306 may maintain a free chunk list (not shown) indicating which of the chunks 504 is available for allocating to the linked list 502. Additionally, when a chunk of LLR memory is de-allocated (i.e., when LLR values for a given transport block are no longer needed), the free chunk list is updated to reflect that the chunk of LLR memory is now available for re-allocation

According to certain aspects of the present disclosure, the LLR memory 500 may contain more than one linked list 502 of chunks, each linked list corresponding to a different transport block being processed by the communications apparatus 300. As described above, in some cases, the memory space 500 may store a linked list, which corresponds to a large transport block, comprising many chunks for storing a large amount of LLRs. In other cases, the LLR memory 500 may store other linked lists, which correspond to a small transport block, comprising fewer chunks for storing a smaller amount of LLRs. In both cases, rather than allocate a fixed amount of memory spaces for all linked lists, which may waste space, each of the linked lists is dynamically allocated a different amount of chunks according to storage requirements of the transport block. Accordingly, certain aspects of the present disclosure efficiently manage LLR memory to store LLR values for a variety of transport block sizes at the same time.

FIG. 5B illustrates a linked list 502 of chunks 504 in LLR memory 500. As described, for example, a plurality of chunks 504 may be linked together to store LLRs from a code block of a given transport block. Additional chunks 504 that store LLRs from other code blocks of the same transport block may also be linked together to comprise a linked list 502 storing LLRs for a given transport block.

In the example shown in FIG. 5B, the head pointer 506 is initialized to refer to chunk 2193. To store LLRs for a first code block (identified as Code Block 1, or “CB1”) of a given transport block, the linked list 502 includes additional chunks 504. As shown, two chunks identified as chunks 2193 and 2192 are allocated to store LLRs for the first code block. As such, the linked list 502 is updated to link together chunk 2193 and chunk 2192, as depicted by an arrow in FIG. 5B.

As shown in FIG. 5C, the LLR manager 306 determines a next available chunk to store LLRs for a second code block, identified as Code Block 2 (or, “CB2”) of a given transport block. The LLR manager 306 may dynamically allocate non-contiguous chunks for flexible and efficient use of the LLR memory. It is understood that contiguous chunks of LLR memory may be used to store LLRs for different transport blocks for different users at a given time. Accordingly, the LLR manager 306 dynamically determines, at a time needed to store the LLRs, a next available chunk. As shown, the next available chunks to store LLRs for the second code block are identified as chunks 2199, 2197, and 2196. As such, the linked list 502 indicates linkages between chunks 2193 and 2192, and now further includes chunks 2199, 2197, and 2196.

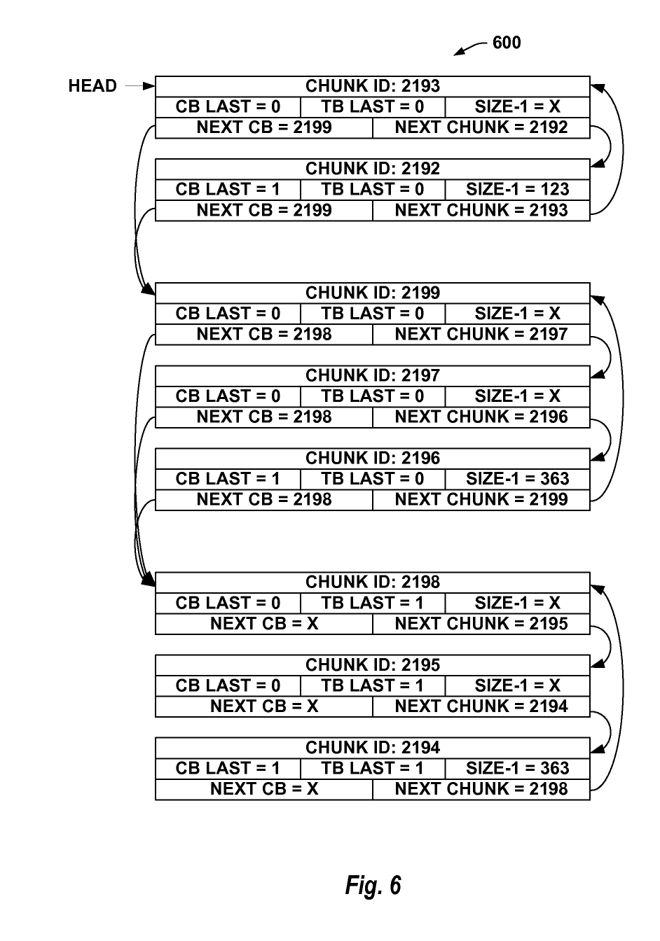

Finally, the LLR manager 306 determines next available chunks to store LLRs for a third code block, referred to as Code Block 3 (or “CB3”) of the given transport block. As shown in FIG. 5D, the linked list 502 is updated to further include chunks identified as chunks 2198, 2195, and 2194 in LLR memory FIG. 6 illustrates a linked list configuration 600 defined for the linked list 502, according to aspects of present disclosure. In one example, a linked list configuration 600 includes a plurality of fields that specify values for traversing the linked list 502. As noted above, the field values can be specified in a word or other block of memory for each chunk in a linked list that can be accessed by hardware circuit.

For the example depicted in FIG. 6, it is assumed that a linked list is generated based on a 2000-bit transport block comprising three code blocks, one 400-bit code block and two 800-bit code blocks. In this specific example, the three code blocks are turbo coded at rate ⅓. As such, LLRs of size 1,148 (3*400+12−2*32) for the 400-bit code block are needed, and LLRs of size 2,412 (3*800+12) for the two 800 bit code blocks. According to certain aspects, the 32 bits may indicate filler bits for communicating the 400-bit code block. Thus, if LLR chunks may store 1,024 LLRs each, two LLR chunks are allocated for the 400 bit code block and 3 LLR chunks are allocated for each of the 800 bit code block.

According to certain aspects, the chunk configuration 600 may include a chunk identifier field (chunk ID) that identifies a LLR chunk, a code block (CB) last field that indicates whether a chunk is the last chunk in a related code block, and a transport block (TB) last field that indicates whether a code block is the last in a related transport block. While chunks may be configured to store a pre-determined amount of LLRs (e.g., 1,024 LLRs), the chunk configuration 600 may also include a size field indicating a size of the LLR chunk for those cases where not all of a given LLR chunk is used for storing LLRs the transport block or code block. In certain aspects, the size field may be equal to the number of LLRs stored in the chunk minus 1.

The chunk configuration 600 may further include a next CB identifier field that identifies a next code block in the related transport block, and a next chunk identifier field that indicates the next chunk in the related code block. As depicted, a next chunk identifier field for the last chunk in a code block can point to the first chunk in the code block to allow traversal to loop through the chunks.

Referring back to the specific example above, chunks identified as 2193 and 2192 are allocated to store LLR values for the 400-bit code block CB1. In a linked list configuration corresponding to chunk 2193, the chunk ID field is set to 2193 and the next chunk field is set to indicate chunk 2192. In a linked list configuration corresponding to chunk 2192, the chunk ID field is set to 2192 and a size field of chunk 2192 is set to a value of 124 because only 124 LLRs of the second chunk 2192 are needed (1148−1024). Because chunk 2192 is the last chunk in the code block CB1, the CB-last field of chunk 2192 is set to true, or 1, and the next chunk field is set to the first chunk in CB1, or chunk 2193. In both linked list configurations for chunks 2193 and 2192, the next code block field is set to indicate the first chunk allocated to store LLRs for a next code block related to the given transport block. In this case, the next code block field is set to identify chunk 2199, as discussed below.

As shown, in the example, chunks identified as 2199, 2197, and 2196 are allocated to store LLRs for the first 800 bit code block CB2. For example, in linked list configurations corresponding to chunks 2199, 2197, and 2196, the next chunk field is set to indicate chunks 2197, 2196, and 2199, respectively. Because only 364 LLRs are needed in the last chunk 2196 (2412−2*1024), the size field of chunk 2196 is set to 363. Because chunk 2196 is the last chunk of the code block CB2, the CB-last field for chunk 2196 is set to true, or 1.

Similarly, chunks identified as 2198, 2195, and 2194 may be allocated to store LLRs for the second 800 bit code block CB3, which in this example is the last code block in the transport block. Thus, in the linked list configuration corresponding to chunks 2198, 2195, and 2194, the TB-last field is set to 1. Further, the next chunk fields are set to indicate chunks 2195, 2194, and 2198, respectively. As described, these parameters can be stored for each chunk and provided to a hardware circuit, as described above. In certain aspects, the parameters can be provided directly, as a pointer to the parameters and/or the head of the list, etc. The hardware circuit can traverse the linked list utilizing the parameters of the linked list configuration 600 to fetch LLR values stored in LLR memory for a given transport block.

For example, the hardware circuit can begin at the chunk identified as 2193, which is indicated as the head of the linked list 502 for this given transport block. The hardware circuit can process data in the chunk and move to chunk 2192 based on the next chunk field contained in the linked list configuration 600. The hardware circuit can determine chunk 2192 is the last chunk in the first code block, as described, based on the CB last field. The hardware circuit can loop back to the first chunk of CB1, chunk 2193, if necessary and/or can move to chunk 2199 to retrieve LLR values for the next code block CB2. The hardware circuit can traverse chunk 2199 and then chunk 2197 and chunk 2196, and can loop back to chunk 2199 if necessary. At any time, the hardware circuit can then retrieve LLR values for the third code block by moving to chunk 2198 and then traverse to chunk 2195, and the chunk 2194. The hardware circuit may determine that code block CB3 is the last code block in the transport block based on the TB last field, as described. Again, the hardware circuit can loop to the beginning of the code block at chunk 2198 if necessary. After processing all chunks in this third code block CB2, the hardware circuit has processed LLR values for the given transport block.

According to certain aspects, the information fields comprising the chunk configuration 600, as described above, represent an amount of information sufficient for the hardware circuit to simply traverse the linked list. The chunk configuration 600 advantageously provides enough information to the hardware circuit such that the hardware circuit may not need to execute additional logic or to maintain additional internal records as the hardware circuit traverses the linked list. Accordingly, the chunk configuration 600 advantageously reduces complexity of the hardware circuit. According to certain aspects, it is contemplated that the chunk configuration 600 may comprise additional information fields to assist the hardware circuit in traversing the linked list.

It is to be appreciated that the hardware circuit only traverses the linked list of chunks of LLR memory to access the LLR values. Generally, the hardware circuit does not perform linked list management operations, such as allocation, de-allocation, de-fragmentation, or other suitable procedures to manage the linked list of chunks. These linked list operations are generally performed by a general computing processor or other suitable means, such as in Layer 1 software. Accordingly, this distribution of operations advantageously permits modifications, such as software improvements or software defect corrections, to linked list management procedures, as described above, without having to replace hardware components of the communications apparatus, such as the hardware circuit. It is also to be appreciated that depicted is but one example of managing linked lists in software for fragmented LLR memory while providing hardware traversal. Other implementations are possible and intended to be covered so long as the implementations allow hardware traversal of the linked lists. Thus, as described, this can allow changes to the software to fix bugs or add functionality to the list management logic without requiring modification of the hardware circuit.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the certain aspects disclosed herein may be implemented or performed with a general purpose processor, a digital signal processor (DSP), an ASIC, a FPGA or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the certain aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure. Thus, the present disclosure is not intended to be limited to the aspects shown herein but is to be accorded the widest scope consistent with the principles and novel features disclosed herein.

What is claimed is:

1. A method for wireless communications, comprising:
generating a linked list of chunks of memory used to store logarithmic likelihood ratio (LLR) values for a transport block, wherein each chunk holds LLR values for a code block of the transport block; and
providing the linked list to a hardware circuit for traversal.

2. The method of claim 1, wherein LLR values for each code block are stored in one or more chunks of the linked list.

3. The method of claim 1, wherein the code blocks of the transport block comprise code blocks of different sizes.

4. The method of claim 1, wherein providing the linked list comprises:
setting a plurality of parameters, readable by the hardware circuit, for each chunk in the linked list.

5. The method of claim 4, wherein the plurality of parameters for each chunk comprises:
a next chunk field indicating a next chunk for a corresponding code block of the transport block.

6. The method of claim 5, wherein the next chunk field of a last chunk in a related set of linked chunks indicates a first chunk in the related set of linked chunks for the corresponding code block.

7. The method of claim 4, wherein the plurality of parameters for each chunk comprise:
a code block last field that indicates whether the chunk is a last chunk in a related set of linked chunks for a corresponding code block.

8. The method of claim 4, wherein the plurality of parameters for each chunk comprise:
a transport block last field that indicates whether the chunk is a last in a related set of linked chunks for the transport block.

9. The method of claim 4, wherein the plurality of parameters for each chunk comprise:
a size field indicating an amount of LLR values stored in the chunk.

10. The method of claim 4, wherein the plurality of parameters for each chunk comprise:
a next code block identifier indicating a chunk in which LLR values for a next code block of the transport block are stored.

11. The method of claim 10, wherein each chunk in a related set of linked chunks for a corresponding code block has the same next code block identifier.

12. The method of claim 1, wherein the hardware circuit comprises at least one of an application specific integrated circuit (ASIC), a field programmable gate array (FPGA), and a configurable logic block.

13. The method of claim 1, wherein the each chunk is substantially the same size.

14. An apparatus for wireless communications, comprising:
a logarithmic likelihood ratio (LLR) memory for storing logarithmic likelihood ratio (LLR) values of a transport block;
a linked list manager configured to generate a linked list of chunks of the LLR memory, wherein each chunk holds LLR values for a code block of the transport block; and
a hardware circuit configured to traverse the linked list as provided by the linked list manager.

15. The apparatus of claim 14, wherein LLR values for each code block are stored in one or more chunks of LLR memory of the linked list.

16. The apparatus of claim 14, wherein the code blocks of the transport block comprise code blocks of different sizes.

17. The apparatus of claim 14, wherein the linked list manager is further configured to set parameters, readable by the hardware circuit, for each chunk in the linked list.

18. The apparatus of claim 17, wherein the parameters comprise, for each chunk:
a next chunk field indicating a next chunk for a corresponding code block of the transport block.

19. The apparatus of claim 18, wherein the next chunk field of a last chunk in a related set of linked chunks indicates a first chunk in the related set of linked chunks for the corresponding code block.

20. The apparatus of claim 17, wherein the parameters for each chunk comprises:
a code block last field that indicates whether the chunk is a last chunk in a related set of linked chunks for a corresponding code block.

21. The apparatus of claim 17, wherein the parameters for each chunk comprise:
a transport block last field that indicates whether the chunk is a last in a related set of linked chunks for the transport block.

22. The apparatus of claim 17, wherein the parameters for each chunk comprise:
a size field indicating an amount of LLR values stored in the chunk.

23. The apparatus of claim 17, wherein the parameters for each chunk comprise:
a next code block identifier indicating a chunk in which LLR values for a next code block of the transport block are stored.

24. The apparatus of claim 23, wherein each chunk in a related set of linked chunks for a corresponding code block has the same next code block identifier.

25. The apparatus of claim 14, wherein the each chunk is substantially the same size.

26. The apparatus of claim 14, wherein the hardware circuit comprises at least one of an application specific integrated circuit (ASIC) a field programmable gate array (FPGA), and a configurable logic block.

27. An apparatus for wireless communications, comprising:
means for generating a linked list of chunks of memory used to store logarithmic likelihood ratio (LLR) values for a transport block, wherein each chunk holds LLR values for a code block of the transport block; and
means for providing the linked list to a hardware circuit for traversal.

28. The apparatus of claim 27, wherein LLR values for each code block are stored in one or more chunks of the linked list.

29. The apparatus of claim 27, wherein the code blocks of the transport block comprise code blocks of different sizes.

30. The apparatus of claim 27, wherein means for providing the linked list comprises:
means for setting a plurality of parameters, readable by the hardware circuit, for each chunk in the linked list.

31. The apparatus of claim 30, wherein the plurality of parameters for each chunk comprises:
a next chunk field indicating a next chunk for a corresponding code block of the transport block.

32. The apparatus of claim 31, wherein the next chunk field of a last chunk in a related set of linked chunks indicates a first chunk in the related set of linked chunks for the corresponding code block.

33. The apparatus of claim 30, wherein the plurality of parameters for each chunk comprise:
a code block last field that indicates whether the chunk is a last chunk in a related set of linked chunks for a corresponding code block.

34. The apparatus of claim 30, wherein the plurality of parameters for each chunk comprise:
a transport block last field that indicates whether the chunk is a last in a related set of linked chunks for the transport block.

35. The apparatus of claim 30, wherein the plurality of parameters for each chunk comprise:
a size field indicating an amount of LLR values stored in the chunk.

36. The apparatus of claim 30, wherein the plurality of parameters for each chunk comprise:
a next code block identifier indicating a chunk in which LLR values for a next code block of the transport block are stored.

37. The apparatus of claim 36, wherein each chunk in a related set of linked chunks for a corresponding code block has the same next code block identifier.

38. The apparatus of claim 27, wherein the hardware circuit comprises at least one of an application specific integrated circuit (ASIC), a field programmable gate array (FPGA), and a configurable logic block.

39. The apparatus of claim 27, wherein the each chunk is substantially the same size.

40. A computer-program product comprising a computer-readable medium having instructions stored thereon, the instructions executable by one or more processors for:
generating a linked list of chunks of memory used to store logarithmic likelihood ratio (LLR) values for a transport block, wherein each chunk holds LLR values for a code block of the transport block; and
providing the linked list to a hardware circuit for traversal.

41. The computer-program product of claim 40, wherein LLR values for each code block are stored in one or more chunks of the linked list.

42. The computer-program product of claim 40, wherein the code blocks of the transport block comprise code blocks of different sizes.

43. The computer-program product of claim 40, wherein the instructions for providing the linked list comprises instructions for:
setting a plurality of parameters, readable by the hardware circuit, for each chunk in the linked list.

44. The computer-program product of claim 43, wherein the plurality of parameters for each chunk comprises:
a next chunk field indicating a next chunk for a corresponding code block of the transport block.

45. The computer-program product of claim 44, wherein the next chunk field of a last chunk in a related set of linked chunks indicates a first chunk in the related set of linked chunks for the corresponding code block.

46. The computer-program product of claim 43, wherein the plurality of parameters for each chunk comprise:
a code block last field that indicates whether the chunk is a last chunk in a related set of linked chunks for a corresponding code block.

47. The computer-program product of claim 43, wherein the plurality of parameters for each chunk comprise:
a transport block last field that indicates whether the chunk is a last in a related set of linked chunks for the transport block.

48. The computer-program product of claim 43, wherein the plurality of parameters for each chunk comprise:
a size field indicating an amount of LLR values stored in the chunk.

49. The computer-program product of claim 43, wherein the plurality of parameters for each chunk comprise:
a next code block identifier indicating a chunk in which LLR values for a next code block of the transport block are stored.

50. The computer-program product of claim 49, wherein each chunk in a related set of linked chunks for a corresponding code block has the same next code block identifier.

51. The computer-program product of claim 40, wherein the hardware circuit comprises at least one of an application specific integrated circuit (ASIC), a field programmable gate array (FPGA), and a configurable logic block.

52. The computer-program product of claim 40, wherein the each chunk is substantially the same size.
